(19) United States
(12) Patent Application Publication
(10) Pub. No.: US 2016/0208073 A1
(43) Pub. Date: Jul. 21, 2016

(54) METHOD FOR PRODUCING RADIATION-RESISTANT POLYMER COMPOSITE MATERIALS

(71) Applicant: UT-Battelle, LLC, Oak Ridge, TN (US)

(72) Inventors: Mariappan Parans PARANTHAMAN, Knoxville, TN (US); Tomonori SAITO, Knoxville, TN (US); Tolga AYTUG, Knoxville, TN (US); Keith John LEONARD, Knoxville, TN (US); Robert C. DUCKWORTH, Knoxville, TN (US); Georgios POLYZOS, Oak Ridge, TN (US); Kunlun HONG, Knoxville, TN (US)

(21) Appl. No.: 14/996,487

(22) Filed: Jan. 15, 2016

Related U.S. Application Data
(60) Provisional application No. 62/105,796, filed on Jan. 21, 2015.
(60) Provisional application No. 62/104,149, filed on Jan. 16, 2015.

(51) Int. Cl. C08K 3/22; C08K 3/36

(52) U.S. Cl. CPC C08K 3/22; C08K 3/36; C08K 2003/222

(57) ABSTRACT

A method for producing a polymer-metal oxide composite material resistant to degradation resulting from exposure to gamma irradiation, the method comprising exposing a composite precursor comprised of a heat-resistant polymer in which metal oxide nanoparticles are incorporated to gamma irradiation of at least 1 MRad in a flowing gas atmosphere for a period of at least 12 hours. The resulting radiation-resistant composite material and shaped articles of the material are also described.

### CROSS REFERENCE TO RELATED APPLICATION

The present application claims benefit of U.S. Provisional Application No. 62/105,796, filed on Jan. 21, 2015, and U.S. Provisional Application No. 62/104,149, filed on Jan. 16, 2015, all of the contents of which are incorporated herein by reference.

### GOVERNMENT SUPPORT

This invention was made with government support under Prime Contract No. DE-AC05-00OR22725 awarded by the U.S. Department of Energy. The government has certain rights in the invention.

### FIELD OF THE INVENTION

The present invention relates, generally, to polymer-metal oxide composite materials, and more particularly, to methods of producing such materials and applying such materials as radiation-resistant components, particularly, electrical cabling or shielding materials, in a radiation-emitting environment.

### BACKGROUND OF THE INVENTION

The quality and performance of cable insulation can impact the ability of operators to control instruments and activate safety controls and auxiliary power systems during daily operations and off-normal emergency events over the lifetime of a nuclear power plant (NPP). Cable insulations in nuclear reactors are deployed in a unique environment compared to other applications in that these materials must remain mechanically and electrically sound over a 40-year or greater lifetime as they are exposed to the deleterious combined effects of radiation, mechanical stresses, temperatures exceeding 100° C., and humid environments.

While a variety of cable insulation materials, such as polyimide (PI), cross-linked polyethylene (XLPE), ethylene propylene rubber (EPR), polyvinyl chloride (PVC), neoprene, and chlorosulfonated polyethylene, have generally shown suitable radiation tolerance and met the requirements for cable insulations in current nuclear environments, a number of cable failures have been observed within a 20-30 year time frame under normal service conditions (e.g., IEEE, IEEE Standard for Qualification Class lE Equipment for Nuclear Power Generating Stations, IEEE 323-1974, Institute of Electrical and Electronics Engineers, 1974). Investment in cable aging management programs by DOE, EPRI, and the NRC has furthered understanding of cable aging performance in materials currently deployed in NPP, as evidenced by R. Bernstein, et al., “Expanded Material Degradation Assessment, Volume 5: Aging of Cable and Cable Systems”, United States Nuclear Regulatory Commission, NUREG/CR-7153, vol. 5, 2014.

However, current insulation materials may not be able to sufficiently meet the future and/or next generation nuclear reactor requirements that will operate for longer time periods (60-80 years) under higher thermal and radiation operating loads or exposure to abnormal conditions. For this reason, there would be a significant benefit in electrical cabling materials having an improved ruggedness, particularly radiation and thermal resistance along with exceptional mechanical robustness, to better withstand the harsh conditions of a nuclear power facility.

### SUMMARY OF THE INVENTION

The invention is foremost directed to a method for producing polymer composite materials having an exceptional ability to function as electrical cabling and other useful materials with minimal degradation or failure in harsh environments, particularly environments that include high energy irradiation, such as gamma irradiation. The harsh conditions can further include, for example, exposure to elevated temperatures, exposure to water or saline solution, and high humidity. Due to their overall robustness, the composite materials described herein can find uses beyond cabling, such as in structural applications, as radiation shields, and protective surfaces.

In particular embodiments, the method includes exposing a composite precursor, which includes a heat-resistant polymer in which metal oxide nanoparticles are incorporated, to gamma irradiation doses of at least 1, 5, or 10 MRads for a period of at least 12, 24, or 48 hours. The result is a polymer-metal oxide composite material resistant to degradation resulting from exposure to gamma radiation, which may also be accompanied by a high temperature condition and/or exposure to high humidity or corrosive water.

### BRIEF DESCRIPTION OF THE DRAWINGS

FIG. 1. Graph plotting breakdown of pure polyimide (PI) film and PI film with 1 wt % and 3 wt % SiO₂ nanoparticles incorporated therein.

FIG. 2. Graph plotting failure probability vs. electric field for PI film with 1, 3, and 5 wt % MgO nanoparticles incorporated therein when subjected to 18 MRad gamma irradiation.

FIG. 3. Graph plotting Weibull parameter (α) vs. percentage of nanoparticle addition to determine effect of nanoparticle concentration on magnitude of breakdown strength at different radiation doses and temperature conditions.

FIG. 4. Graph plotting Weibull parameter (β) vs. percentage of nanoparticle addition to determine effect of nanoparticle concentration on shape parameter at different radiation doses and temperature conditions.

FIG. 5. A longitudinal cross-section view of the gamma profile used in gamma irradiation of XLPE-metal oxide composites.

FIG. 6. Graph plotting breakdown with respect to failure probability for XLPE nanocomposites with different concentrations of SiO₂ nanoparticles after gamma exposure in argon atmosphere at 38° C. at an accumulated dose of 18 MRad.

FIG. 7. Graph showing electrical performance with respect to electrical breakdown of thermally aged XLPE-MgO nanocomposites, in air at a temperature of 120° C., by plotting failure probability vs. electric field for XLPE-MgO nanocomposites containing 3 wt % MgO at 1, 3, and 5 weeks of 120° C. temperature condition.

FIG. 8. Graph showing electrical performance with respect to electrical breakdown of thermally aged XLPE-SiO₂ nanocomposites, in air at a temperature of 120° C., by plotting failure probability vs. electric field for XLPE-SiO₂ nanocomposites containing 3 wt % SiO₂ at 1, 3, and 5 weeks of 120° C. temperature condition.

FIGS. 9A-9C. ATR-FTIR spectra for: irradiated XLPE SiO₂ nanocomposites at 18 MRad dosage for XLPE only (FIG. 9A), XLPE with 1 wt % SiO₂ nanoparticles (FIG. 9B), and XLPE with 3 wt % SiO₂ nanoparticles (FIG. 9C).

FIGS. 10A-10C. ATR-FTIR spectra for: thermally aged XLPE with 3 wt. % SiO₂ nanoparticles after undergoing treatment at 120° C. for 1 week (FIG. 10A), 3 weeks (FIG. 10B), and 5 weeks (FIG. 10C).

### DETAILED DESCRIPTION OF THE INVENTION

The method for producing the polymer-metal oxide composite material resistant to irradiative degradation generally includes exposing (i.e., subjecting) a polymer-metal oxide composite material (i.e., “composite precursor”) to gamma irradiation (i.e., “gamma radiation”) of at least 1 MRad in a flowing gas atmosphere for a period of at least 12 hours. The gamma irradiation can be provided by any suitable source of such radiation known in the art. Typically, the source of gamma radiation is a material that undergoes gamma radiative decay. Such gamma-emitting materials are well known in the art, and include, for example, spent fuel elements.

In a first embodiment, the flowing gas contains oxygen (O₂) gas, such as air, oxygen-elevated air, or pure oxygen. In a second embodiment, the flowing gas is composed of one or more inert gases, such as nitrogen or a noble gas (e.g., argon). The inert gas generally contains a substantial absence of oxygen, generally up to or less than 1 vol %, 0.1 vol %, or 0.01 vol % oxygen, or a complete absence of oxygen. In some embodiments, the gas contains a substantial or complete absence (as defined above) of other possible gases, such as carbon dioxide, methane, ammonia, water, and halogenated hydrocarbons.

In different embodiments, the polymer-metal oxide composite is subjected to gamma irradiation of at least or above 1, 5, 10, 15, 20, 30, 40, 50, 60, 70, 80, 90, or 100 MRad and up to, for example, 150 or 200 MRad, or the gamma radiation can be within a range bounded by any of the foregoing exemplary values provided above, e.g., 1-200 MRad, 5-200 MRad, 10-200 MRad, 1-150 MRad, 5-150 MRad, 10-150 MRad, 1-100 MRad, 5-100 MRad, 10-100 MRad, 1-50 MRad, 5-50 MRad, or 10-50 MRad. The radiation dosage may alternatively be expressed in gray (Gy) units, where 100 rads=1 gray. The composite precursor is subjected to any of the above exemplary doses of gamma radiation for a time period (i.e., “exposure time”) of at least or more than 12, 18, 24, 30, 36, 42, 48, or 96 hours, or within a range bounded by any two of these foregoing exemplary time periods (e.g., 12-96 hours, 12-48 hours, 24-96 hours, or 24-48 hours). In some embodiments, the composite precursor is subjected to any of the above exemplary doses of gamma radiation for a longer period of time, e.g., at least 5 days, or at least 1, 2, 3, 4, 5, or 6 weeks, or within a period of time bounded by any two of any of the time periods provided above (e.g., at least 12, 18, or 24 hours and up to 1, 2, 3, 4, or 5 weeks).

The dosage of gamma radiation and the amount of exposure time should be selected such that the composite precursor being exposed to the radiation does not diminish in physical strength or heat resistance or at least maintains sufficient physical integrity and heat resistance for its intended purpose. In some embodiments, the dosage of gamma radiation and the amount of exposure time should be selected such that the composite precursor being exposed to the radiation improves in physical integrity (e.g., strength) or heat resistance. In some embodiments, the dosage of gamma radiation is lower than the amount of radiative dosage than what the composite material is intended to withstand or will ultimately experience in its real world environment.

In some embodiments, the radiative exposure, described above, is accompanied by (i.e., simultaneous with, prior to, and/or after the radiative exposure) exposure of the composite precursor to an elevated temperature, which is herein a temperature above standard ambient temperature, i.e., above 25° C. or 30° C. In different embodiments, the elevated temperature is at least or above 30° C., 40° C., 50° C., 60° C., 70° C., 80° C., 90° C., 100° C., 120° C., 150° C., or 180° C., or a temperature within a range bounded by any two of the foregoing exemplary values.

The polymer in the polymer-metal oxide composite (and in the precursor, i.e., before radiative exposure) can be any solid polymer known in the art to have sufficient heat resistance and physical properties for use in moderate to high temperature applications, such as in electrical cabling. Typically, the polymer considered herein possesses a thermal decomposition temperature, which may be a pyrolysis temperature and/or volatiles emission temperature of at least or above, for example, 100° C., 120° C., 150° C., 180° C., 200° C., 220° C., 250° C., 280° C., or 300° C. In some embodiments, the polymer may possess a glass transition temperature (T_{g}) equivalent to any of the exemplary temperatures above or within a range bounded by any two of the exemplary temperatures above. The polymer may, in some embodiments, possess an ultimate tensile strength of at least or above 50, 100, 150, 200, 250, 300, 400, or 500 MPa. The polymer also typically includes a certain amount of elasticity, such as evidenced by a tensile modulus of about, up to, or less than 0.5, 1, 1.5, 2, 3, 4, 5, 6, 7, 8, 9, 10, 11, or 12 GPa, or a tensile modulus within a range bounded by any two of these values.

In some embodiments, the polymer possesses saturated, unsaturated, aliphatic, or aromatic rings in the backbone (i.e., linking or interconnected) portion of the polymer, wherein the saturated, unsaturated, aliphatic, or aromatic rings may be constructed only of ring carbon atoms or constructed of ring carbon atoms and ring heteroatoms, wherein heteroatoms include, for example, one or more of nitrogen, oxygen, and/or sulfur. The polymer may or may not also or alternatively contain such rings as pendant groups, i.e., pendant from the backbone. The backbone and/or pendant rings may also be polycyclic, such as, for example, a monocyclic, fused bicyclic, or bridged bicyclic ring. In some embodiments, the polymer is cross-linked, while in other embodiments the polymer is uncrosslinked. Some examples of such polymers include, for example, a polyimide (PI), cross-linked polyethylene (XLPE), polyaryletherketone (PAEK), polyetherimide (PEI), ethylene propylene rubber (EPR), ethylene propylene diene monomer (EPDM) rubber, chlorosulfonated polyethylene (CSPE) synthetic rubber, polytetrafluoroethylene (PTFE), polysulfone, polybenzimidazole (PBI), polyvinyl chloride (PVC), chlorinated polyvinyl chloride (CPVC), polyphthalamide (PPA), silicone rubber (SiR), polybenzoxazole, polybenzothiazole, poly(p-phenylene sulfide), and polyquinoxaline. The polymer may also be a blend or composite of any two or more of the polymers described above, or a blend or composite of any of the above exemplary polymers and one or more polymers not exemplified above, as long as the blend or composite remains a heat-resistant solid polymer. In some embodiments, any one or more classes or specific types of polymers described above are excluded from the composite precursor.

The metal oxide nanoparticles can have any of the solid metal oxide compositions known in the art. The metal in the metal oxide can be or include any one or more elements of the Periodic Table capable of forming stable oxide compositions. The metal oxide can be, for example, an oxide of one or more metals selected from alkali metals, alkaline earth metals, transition metals (Groups 3-12 of the Periodic Table), main group metals (Groups 13-15 of the Periodic Table), and rare earth metals, which include the lanthanides and actinides. Some examples of alkali metal oxides include lithium oxide (Li₂O), Na₂O, K₂O, and Rb₂O. Some examples of alkaline earth metal oxides include magnesium oxide (MgO), CaO, SrO, and BaO. Some examples of transition metal oxides include titanium oxides (e.g., TiO₂), scandium oxides (e.g., Sc₂O₃), vanadium oxides (e.g., V₂O₅ and VO), chromium oxides (e.g., Cr₂O₃), manganese oxides (e.g., MnO₂ and Mn₂O₃), iron oxides (e.g., Fe₂O₃, Fe₃O₄, and FeO), cobalt oxides (e.g., Co₂O₃ and Co₃O₄), nickel oxides (e.g., Ni₂O₃ and NiO), copper oxides (e.g., CuO and Cu₂O), zinc oxide (ZnO), yttrium oxides (e.g., Y₂O₃), zirconium oxides (e.g., ZrO₂), niobium oxides (e.g., NbO₂, Nb₂O₅, and TiNb₂O₇), ruthenium oxides (e.g., RuO₂), palladium oxides (e.g., PdO), silver oxide (Ag₂O), cadmium oxide (CdO), hafnium oxide (HfO₂), tantalum oxide (Ta₂O₅), tungsten oxides (e.g., WO₂), and platinum oxide (PtO₂), any of which may be a polyoxometalate, where applicable. Some examples of main group metal oxides include SiO₂ (i.e., “silicon oxide” or “silica”), aluminum oxide (e.g., Al₂O₃), boron oxide (e.g., B₂O₃), gallium oxide (Ga₂O₃), tin oxide (e.g., SnO or SnO₂), germanium oxide (e.g., GeO₂), indium oxide (e.g., In₂O₃), lead oxide (e.g., PbO or PbO₂), antimony oxide (e.g., Sb₂O₃ or Sb₂O₅), and bismuth oxide (e.g., Bi₂O₃). Some examples of rare earth metal oxides include CeO, Ce₂O₃, Sm₂O₃, Eu₂O₃, Gd₂O₃, and Tb₂O₃. In some embodiments, the metal oxide is selected from oxides of silicon, magnesium, aluminum, titanium, and lanthanum oxides, or a sub-selection thereof. In some embodiments, any one or more classes or specific types of metal oxide compositions described above are excluded from the composite precursor.

The metal oxide may also contain two or more metals independently selected from any of the foregoing types of metals (e.g., binary or ternary metal oxide compositions containing two, three, or more metals independently selected from alkali, alkaline earth, main group, transition metal, and rare earth metals). The metal oxide containing more than one metal can be, for example, a spinel metal oxide (e.g., CoMn₂O₄, ZnMn₂O₄, MgAl₂O₄, CoFe₂O₄, MnFe₂O₄, or LiMn₂O₄) or perovskite metal oxide (e.g., CaTiO₃, SrTiO₃, BaTiO₃, LiNbO₃, BaZrO₃, and LaAlO₃). In some embodiments, the metal oxide may or may not include metal-binding groups other than oxide attached to the metal. The other metal-binding groups may be, for example, hydroxyl (OH), halide (e.g., F, Cl, or Br), complex inorganic anion (e.g., carbonate or sulfate), or chelating or non-chelating organic ligand (e.g., a carboxylate, dicarboxylate, alkoxide, phenoxide, pyridine, bipyridine, acetylacetonate, or salicylaldehyde ligand). In some embodiments, the metal oxide material includes only one or more types of metal ions along with oxide ions, and may or may not include an organic ligand.

The metal oxide nanoparticles generally have a particle size of up to or less than 1000 nm. In different embodiments, the nanoparticles have a size (or average size) of up to or less than, for example, 500 nm, 250 nm, 200 nm, 150 nm, 100 nm, 50 nm, 20 nm, 10 nm, or 5 nm, or a size within a range bounded by any two of the foregoing particle sizes.

The above-described metal oxide compositions are well known in the art, and powder (particulate) versions thereof are either commercially available or can be prepared by means well known in the art. In some embodiments, any one or more classes or specific types of metal oxide compositions, as provided above, are excluded from the composite material.

The metal oxide material is generally included in the composite precursor (and resulting irradiated composite) in an amount of at least 0.1 wt %. In different embodiments, the metal oxide nanoparticles are included in an amount of about, at least, or above 0.1, 0.5, 1, 2, 3, 4, 5, 6, 7, 8, 9, 10, 15, or 20 wt %, or an amount within a range bounded by any two of the foregoing exemplary values, e.g., at least 1 or 2 wt % and up to 3, 4, 5, 6, 7, 8, 9, or 10 wt %. As used herein, the term “about” generally indicates within ±0.5, 1, 2, 5, or 10% of the indicated value. Thus, an amount of “about 10 wt %” generally indicates, in its broadest sense, an amount of 9-11 wt %.

The method described above may also include preparing the composite precursor prior to exposing the composite precursor to gamma irradiation. The composite precursor can be made by any of the methods well known in the art for producing a composite containing a polymer and metal oxide nanoparticles. In a first embodiment, the composite precursor is produced by mixing, blending, or compounding a heat-resistant polymer with metal oxide nanoparticles. The method may further include softening or melting of the polymer. In a second embodiment, the composite precursor is produced by incorporating metal oxide nanoparticles into a process in which the polymer is being synthesized. In a third embodiment, the composite precursor is produced by in situ preparation of metal oxide nanoparticles (e.g., by sol gel synthesis) in a mixture that includes a nanoparticle precursor (e.g., sol gel precursor, such as a metal alkoxide or hydroxide) and the polymer. In a fourth embodiment, the composite precursor is produced by in situ preparation of metal oxide nanoparticles and in situ preparation of the polymer from a mixture that includes a nanoparticle precursor and a polymer precursor. For example, in some embodiments, a metal oxide-polyimide composite is produced by incorporating a metal oxide precursor (e.g., a silicon alkoxide, magnesium alkoxide, aluminum alkoxide, or titanium alkoxide) into a polyimide precursor (e.g., polyamic acid) and contacting the mixture with water to hydrolyze the metal oxide precursor, along with exposure to heat to convert the polyamic acid to polyimide.

In another aspect, the invention is directed to an article having a shape constructed of the above described polymer-metal oxide composite that has been treated by gamma irradiation. The irradiated composite may be made to possess the shape of a useful article either by irradiative treatment of a composite precursor having the same shape (where the shape is retained after irradiation), or by irradiative treatment of a composite precursor having a first shape, but wherein, after irradiation, the treated composite is re-shaped into a second shape appropriate for the useful article. The shape can be, for example, a planar shape (e.g., a sheet), tubular shape (e.g., of a dimension suitable as cable insulation material), rod shape, or block shape. The useful article considered herein is generally of macroscopic size, typically at least 0.5, 1, 5, 10, 50, or 100 centimeters in at least one, two, or all of the three dimensions of the article.

Examples have been set forth below for the purpose of illustration and to describe certain specific embodiments of the invention. However, the scope of this invention is not to be in any way limited by the examples set forth herein.

### Example 1

### Preparation and Characterization of Polyimide-Ceramic Nanocomposite Dielectric Films

Preparation of a Polyimide-Silica Composite

To prepare a film with 3 wt. % loading of SiO₂ nanoparticles, 96.7 microliters of tetraethyl orthosilicate (TEOS) as a silica precursor and 21 microliters of (3-trimethoxysilylpropyl)diethylenetriamine ((TMOSP)-DEPTA) as a surface modifier were dissolved in approximately 2.5 mL dimethylacetamide (DMAc) in a small vial. In another vial, 100 microliters of deionized water was dissolved in approximately 1.75 mL DMAc. When completely dissolved, the first solution (TEOS solution) was gradually added to 5.0 g of polyamic acid (PAA) solution (18 wt. %) over 30 minutes via a funnel while stirring slowly. Next, the water/DMAc solution was added in the same manner over 15 minutes. The solution was stirred for at least 4 hours and then cast evenly on two 2-inch Teflon plates and dried at 70° C. overnight. The films were heated for about 1 hour and 30 minutes at 100° C. and another hour at 200° C. The process was repeated for PI films containing 1, 2, 4, and 5 wt. % SiO₂ nanoparticles.

Preparation of a Polyimide-MgO Composite

To prepare a film with 3 wt. % loading of MgO nanoparticles, 0.0738 g of magnesium ethoxide as a magnesium oxide precursor was mixed with 21 microliters of (TMOSP)-DEPTA hydrolyzed in deionized water (about 0.4 mL) and diluted in DMAc (about 3.5 mL). After mixing thoroughly, the solution was added dropwise to 5.0 g of PAA solution (18 wt. %) over 30 minutes with slow stirring. The solution was stirred for at least 4 hours and then cast evenly on two 2-inch Teflon plates and dried at 70° C. overnight. The films were heated for 1 hour and 30 minutes at 100° C. and another hour at 200° C. The process was repeated for PI films containing 1, 2, 4, and 5 wt. % MgO nanoparticles.

Preparation of a Polyimide-Al₂O₃ Composite

To prepare a film with 3 wt. % loading of Al₂O₃ nanoparticles, 0.0512 g of aluminum isopropoxide as an aluminum oxide precursor was mixed with 21 microliters of (TMOSP)-DEPTA hydrolyzed in deionized water (about 0.4 mL) and diluted in DMAc (about 3.5 mL). After mixing thoroughly, the solution was added dropwise to 5.0 g of PAA solution (18 wt. %) over 30 minutes with slow stirring. The solution was stirred for at least 4 hours and then cast evenly on two 2-inch Teflon plates and dried at 70° C. overnight. The films were heated for 1 hour and 30 minutes at 100° C. and another hour at 200° C. The process was repeated for PI films containing 1, 2, 4, and 5 wt. % Al₂O₃ nanoparticles.

Electrical Breakdown Measurements of the Polyimide Composite Materials

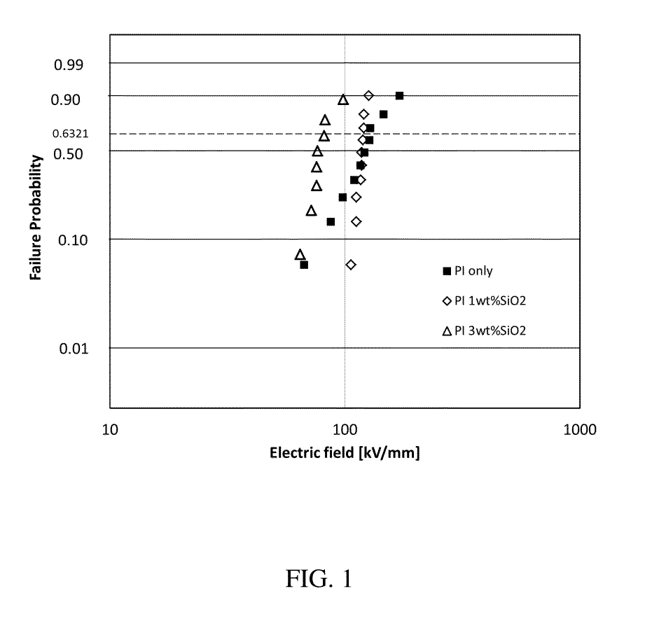

Initial results on the electrical breakdown strength measurements for the PI-SiO₂ composite material are reported in FIG. 1. As shown, the addition of 1 wt. % SiO₂ in PI provides a small improvement over the non-doped material.

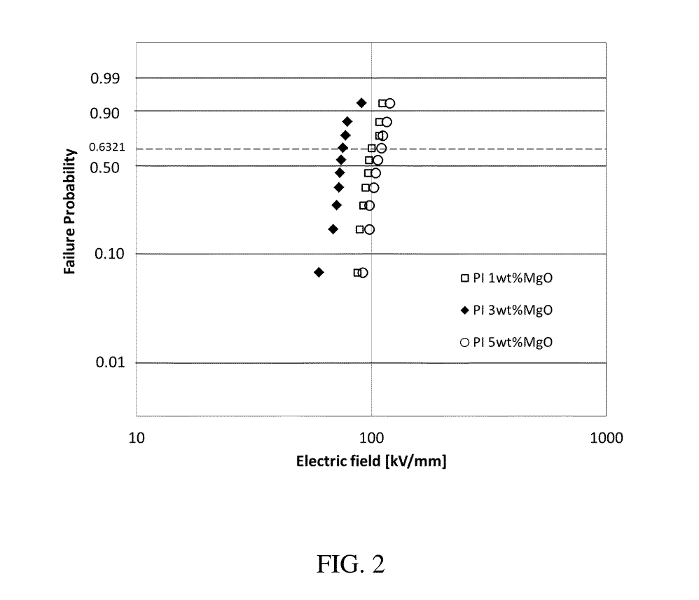

FIG. 2 is a graph plotting failure probability vs. electric field for PI film with 1, 3, and 5 wt % MgO nanoparticles incorporated therein when subjected to 18 MRad gamma irradiation. As shown, the addition of 5 wt. % MgO in PI provides a small improvement over the 1 wt. % MgO containing PI material.

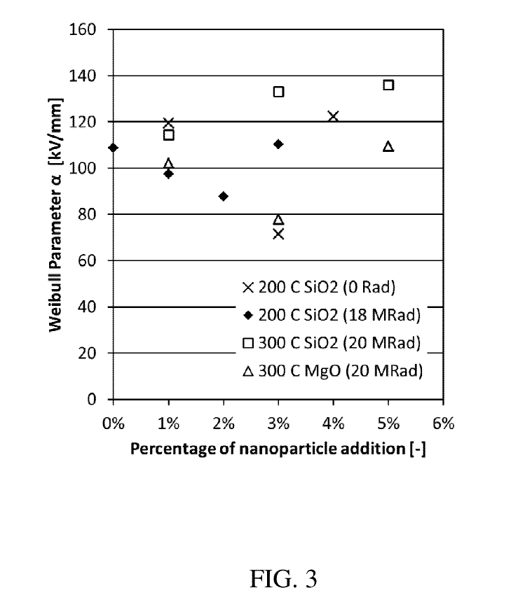

FIG. 3 is a graph plotting Weibull parameter (a) vs. percentage of nanoparticle addition to determine effect of nanoparticle concentration on magnitude of breakdown strength at different radiation doses and temperature conditions. As shown, higher radiation as well as higher temperature conditions improve the parameter for higher wt. % SiO₂ containing PI films.

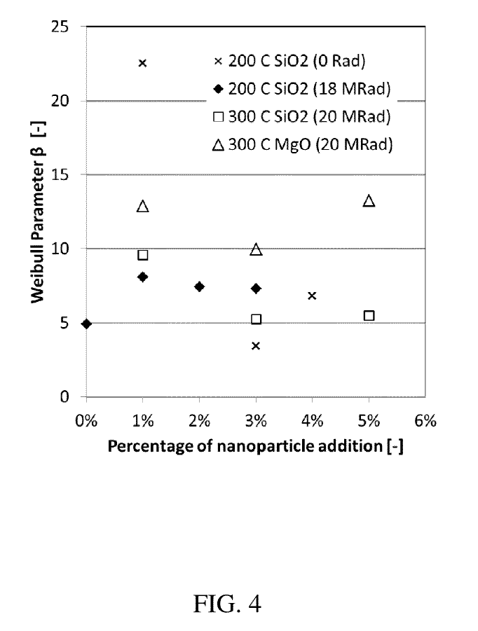

FIG. 4 is a graph plotting Weibull parameter (β) vs. percentage of nanoparticle addition to determine effect of nanoparticle concentration on shape parameter at different radiation doses and temperature conditions. As shown, higher radiation as well as higher temperature conditions decrease the parameter for higher wt. % SiO₂ containing PI films.

### Example 2

### Preparation and Characterization of XLPE-Ceramic Nanocomposite Dielectric Films

Preparation of XLPE-Metal Oxide Composite Films

Two pathways were developed for the fabrication of the XLPE nanocomposite materials. The first pathway employed an in situ method where the nanoparticles are formed within the XLPE. This method has the particular advantage of uniform dispersal of particles by a commercially scalable method with minimal modification of standard XLPE processing conditions. The in situ method can be practiced by, for example, combining nanoparticles with desired polymer precursors, and optionally a solvent (e.g., acetone), then thoroughly blending the components, drying the blend, pressing the blend into a pellet, and finally, hot pressing the blend into a film. The second pathway employed an ex situ method, similar to conventional methods, except that cross-linking chemical agents were added to the polyethylene during twin-screw driven mixing with a known concentration of the nanoparticles to produce the final XLPE composite. The ex situ method can be practiced by, for example, grinding high-density polyethylene (HDPE) (e.g., by using liquid nitrogen cooling to cool the HDPE below the glass temperature for PE and grinding) and blending with desired metal oxide nanoparticles, wherein the metal oxide may be a first, second, or third row transition metal oxide, Group 13 metal oxide, or Group 14 metal oxide, e.g., TiO₂, SiO₂, MgO, Al₂O₃, and hot pressing the blend into a film.

In an alternative procedure, the PE was dissolved in 1,2,4-trichlorobenzene (TCB), and the nanoparticles were added in situ and cast into a film. High-density polyethylene (HDPE) in pellet form with an average molecular weight of 118,000 g/mol was used. Vinyltriethoxysilane (VTES) was used as the source for SiO₂ and tert-butyl peroxide (TBP) was used as the crosslinking agent. About 1 g of HDPE pellets were added to 10 mL of TCB in a 50-mL Teflon® beaker. Desired amounts of VTES and TBP were also added. The mixture was stirred with a magnetic stir bar and heated to 170° C. The amount of peroxide was varied from 0 up to 8 phr (part of reagent per hundred parts of HDPE). The final dissolved mixture was cast into a Teflon® cap while it was still hot. This cap was either left in the hood at room temperature or heated at 140° C. to aid in solvent evaporation. Once no more liquid was visible, the sample was placed in a vacuum oven and heated up to 150° C., at which point vacuum was applied for one hour. The vacuum removed the remainder of the solvent. The sample was then allowed to cool to room temperature and the cap was then pulled off.

For the incorporation of SiO₂ nanoparticles using the in situ method, a silicic acid-based precursor solution was mixed with high-density polyethylene (HDPE), 1,2,4-trichlorobenzene (TCB), ˜4.8% by weight vinyltriethoxysilane (VTES), and 1.7% by weight tert-butyl peroxide (TBP) in a beaker. VTES was utilized as a surface modifier for the SiO₂, and the TBP served to cross-link the polyethylene and initiate chain formation. The beaker was then inserted in a hot oil bath and magnetically stirred until the bath temperature reached 125° C. After additional TCB (20% of the original amount) was added to the solution, heating continued until a temperature of 130-135° C. was reached. The solution was then removed and cast into a Teflon® evaporating dish, which was left in a heated oil bath in a laboratory hood up to 6 hours to evaporate the solvent.

The ex situ method employed in this experiment permitted different nanoparticles to be examined in shorter time than possible with the in situ process. This permitted optimization of performance while minimizing processing time. For ex situ-processed XLPE-based SiO₂ and MgO nano-composite dielectrics, either fumed silica or fumed magnesia, along with desired amounts of HDPE, VTES and TBP, were fed into a 5 cm³ twin-screw micro-compounder and mixed at 200° C. for 10 minutes before being extruded as filaments. The filaments were then placed between two 6″×6″ Teflon® sheets. These sheets were sandwiched between two metal plates and then placed in a hot press with the temperature set at 365° F. (185° C.), force of 11,000 lbs. (48.9 KN), and dwell time of 5 minutes. The Teflon® sheets were then removed from the press and set aside to cool for 30 minutes. Finally, the Teflon® sheets were pulled apart to remove the XLPE/SiO₂ or XLPE/MgO films.

The mass and wt % of VTES and TBP for a given value of polyethylene were calculated using the following equations. If 0.100 mL of VTES and TBP was used,

$${ρ}_{VTES} = 0.903 \frac{g}{ml}$$

$${ρ}_{TBP} = 0.796 \frac{g}{ml}$$

$${m}_{VTBS} = {ρ}_{VTES} \cdot V = 0.903 \frac{g}{ml} \cdot 0.100 ml = 0.0903 g$$

If 1 g of HDPE was used to start with, the wt. % of the samples can be determined as follows:

$$\frac{0.0903 g}{0.0903 g + 1.0 g} = 8.28 \% or 8.28 phr$$

Similarly, the wt. % of TBP can be calculated to determine the volume needed for a sample with a certain phr. Thus, first the grams of VTES or TBP can be determined based on the desired phr, and then the density calculation can be used to determine the volume.

Polymer Ceramic Nanocomposite Film Characterizations

Attenuated Total Reflection-Fourier Transform Infrared Spectroscopy (ATR-FTIR) was performed on a Digilab® FTS 7000 FTIR using Pike Miracle™ Diamond ATR and a DTGS detector from 500-4500 cm⁻¹. Ultraviolet-visible spectra were also obtained. The measurement wavelength range was from 1100 to 190 nm, and testing was performed in the transmittance mode. The wavelength scanning rate was 0.5 s, and the data were recorded at intervals of 2 nm. Differential Scanning calorimetry (DSC) and Thermogravimetric Analysis (TGA) were performed under the same conditions. The heating of the sample was conducted under a nitrogen atmosphere in three steps for XLPE Samples: 1) 20° C.→180° C., 2) 180° C.→20° C., and 3) 20° C.→1000° C., with a ramp rate of 5° C./min. Dielectric Relaxation Spectroscopy (DRS): Novocontrol Alpha-A Impedance Analyzer was used to obtain complex permittivity. The sample was sandwiched between two 20-mm diameter electrodes. The temperature ramp rate was varied for XLPVA samples. The temperature error and temperature change in these measurements were 0.1° C. and 0.1° C./min, respectively.

Thermogravimetric analysis (TGA) measurements were performed on XLPE samples with varying levels of tert-butylperoxide (TBP) to test the effect of TBP on the crosslinking efficiency of the sample. The increase in peroxide content resulted in an increase in the temperature of the onset of degradation. Thus, the peroxide content is directly related to the extent of crosslinking in the sample.

Irradiation of XLPE Nanocomposites

Irradiation of the nano-composite dielectrics was conducted at the Gamma Irradiation Facility (GIF) in the High Flux Isotope Reactor (HFIR) at Oak Ridge National Laboratory. The GIF, located in the reactor bay pool, allows the selection of spent annular fuel assemblies from HFIR to be used for the source of the gamma. Depending on when the assembly was ejected from HFIR, different gamma flux levels can be achieved (e.g., 0.03 MRad/h to 10 MRad/h, which corresponds to 30 Gy/h to 100 kGy/h). The selected fuel assembly produced an average dose rate of 0.56 MRad/hr (5.6 kGy/hr) for the time in which the measurements took place. The samples were placed in a specialized variable position holder that is inserted into a steel irradiation canister and lowered into position within the flux trap of the spent fuel core. Aluminum holders in the variable position holder allow the polymer films to be held in the vertical position. The nanocomposite films were separated by 0.05-mm thick high purity aluminum foil with the stack of films further supported in the fixture by a thicker high purity aluminum backing plate for support. The sample holders can either be set in the extended position or retracted back against a thermal block connected to a rod heater. In the extended position, steel springs press the holders that are shaped to fit against the inside radial wall surface of the steel irradiation canister. Under this configuration, maximum sample cooling is achieved with temperatures averaging around 38° C., which is roughly the outside water temperature in the spent fuel core, which can either increase or decrease depending on the age of the assembly. In the retracted configuration, the samples were connected to the internal rod heater. For the purpose of the instant experiments, the sample holders were placed in the low temperature configuration, with only a surrogate steel tube used for the support column instead of a rod heater. The holders were machined to permit thermocouple placement next to the outermost sample (relative to the radial direction). The alloy 600-sheathed type K thermocouple lines, heater supply, gas purge inlet, and outlet lines exited the irradiation canister via umbilical connection through the spent pool into the HFIR instrument room where temperatures, gas pressure, and flow were monitored. For these tests, argon sweep gas was used. Radiographic dosimetry films were placed next to the nanocomposite films to compliment calculated dose rates, with the dosimetry results used in the reporting of the data.

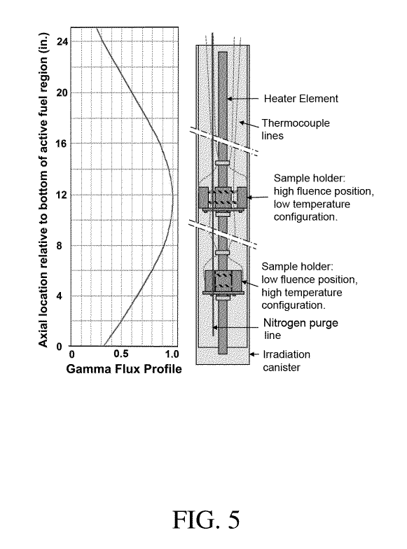

A gamma flux profile along the longitudinal direction of the flux trap is present and was utilized in this work to allow for testing to different accumulated dose levels within the same exposure run. A longitudinal cross-section view of the gamma profile in the HFIR GIF is shown in FIG. 5.

Thermal Aging of XLPE Nanocomposites

Post-annealing studies were performed, wherein, in addition to irradiation, XLPE nanocomposites were also exposed to aging in air at elevated temperatures in a furnace. Thermally treated samples were irradiated separately at about 100° C. or so. After irradiation, they were post-annealed at slightly elevated temperatures. Twenty-seven samples of pure XLPE and XLPE nanocomposites (3 wt. % SiO₂ and 3 wt. % MgO) were arranged within the furnace to allow for exposure of each film in air at 120° C. Samples were removed over a five-week period with nine samples removed after one week, another nine samples after three weeks, and the remaining nine samples removed after five weeks. With three samples of each type (pure, 3 wt. % SiO₂, and 3 wt. % MgO), electrical, mechanical, and chemical characterizations were conducted to determine the impact of the nanoparticles on performance. While no visible degradation was observed at one-week and three-week intervals, degradation was observed for the five-week aging period.

Breakdown Voltages of Irradiated XLPE Nanocomposites

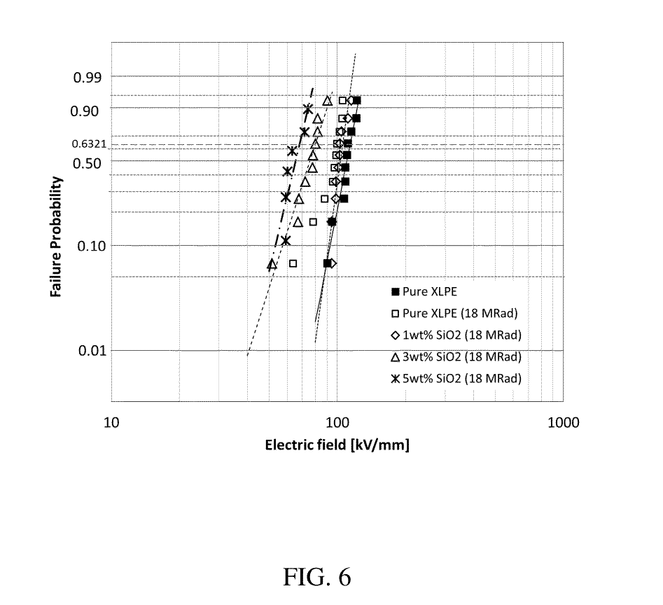

The electrical performance as a function of electrical breakdown of the XLPE nano-composites that were irradiated to a total accumulated dose of 18 MRad is shown in FIG. 6. The electrical performance was quantified with respect to the AC electrical breakdown of the films when a 60 Hz high voltage was applied at a rate of 500 V/s in a LD60 breakdown tester. Given the small sample size of breakdown voltages for each film, Weibull analysis was conducted to determine the performance, Eₒ, and uniformity, β, of each film. These values are shown in Table 1 below.

TABLE 1
Weibull scale and shape parameters for
irradiated XLPE SiO₂ nanocomposites.

| | Accumulated Dose | | |
|---|---|---|---|
| Composition | [MRad] | Eₒ [kV/mm] | β [−] |
| Pure | 0 MRad | 113.6 | 11.26 |
| | 10 MRad | 97.6 | 15.42 |
| | 18 MRad | 99.8 | 6.63 |
| 1 wt. % SiO₂ | 0 MRad | 146.0 | 6.35 |
| | 10 MRad | 96.2 | 7.37 |
| | 18 MRad | 105.6 | 15.90 |
| 3 wt. % SiO₂ | 0 MRad | 100.0 | 6.82 |
| | 10 MRad | 101.9 | 10.37 |
| | 18 MRad | 79.9 | 6.83 |
| 5 wt. % SiO₂ | 0 MRad | n/a | n/a |
| | 10 MRad | 90.2 | 22.63 |
| | 18 MRad | 68.0 | 9.20 |

The addition of 1 wt. % SiO₂ made a small improvement over the non-doped material, with property retention following exposure to 18 MRad. However, a systematic decrease in performance was observed with further increase in SiO₂ concentration. The decrease in performance appears to accelerate with increasing accumulated dose. As the irradiation was performed in argon and not in air, the observed degradation due to irradiation could have resulted from polymer chain interaction with the nanoparticles within the film instead of chemical interaction of the broken polymer chains with oxygen. Since the XLPE nano-composites with 3 wt. % and 5 wt. % SiO₂ exhibited measurable change in performance at 18 MRad, irradiation could have resulted in a negative interaction between polymer and particles, or is indicative of nanoparticle agglomeration in the film reducing their effectiveness in limiting damage to the polymer. Since the non-irradiated Eₒ values are slightly lower in the 3 and 5 wt. % loaded film, the increased agglomeration of the particles may limit the uniformity in distribution of the particles through the polymer film matrix, making them less efficient in neutralizing free radicals or broken polymer chains.

Breakdown Voltages of Thermally Aged XLPE Nanocomposites

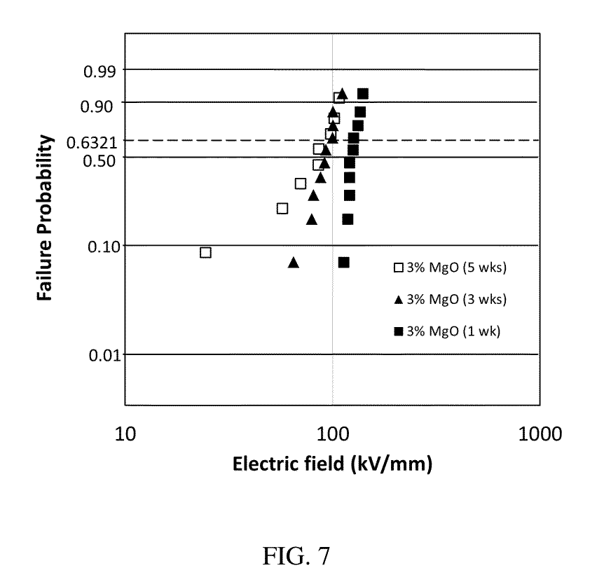

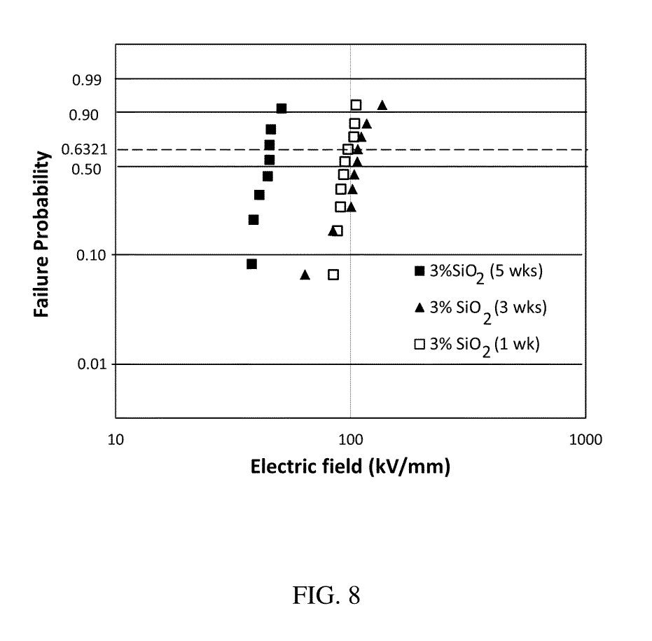

The electrical performance with respect to electrical breakdown of the thermally aged XLPE-MgO nanocomposites, in air at a temperature of 120° C., is plotted in the graph shown in FIG. 7. The electrical performance with respect to electrical breakdown of the thermally aged XLPE-SiO₂ nanocomposites, in air at a temperature of 120° C., is plotted in the graph shown in FIG. 8. From these figures and from Weibull distribution analysis given in Table 2, below, for the different XLPE nanocomposites, there is evidenced a significant change in electrical properties consistent with the observed physical changes discussed above. It is worthy to note that the dissipation factor, tan 6, significantly increased for the pure XLPE and the XLPE nanocomposites with 3 wt. % SiO₂, but there was little change for the XLPE with 3 wt. % MgO despite the physical change in the film's appearance. The AC breakdown performance of the MgO also degraded like the other films. This would suggest that the change in the XLPE MgO film was localized and not as uniform as the other materials.

TABLE 2
Comparison of Weibull parameters and dissipation factor (tan δ) for XLPE
nanocomposites that have been thermally aged at 120° C. for different periods
of time at a relative humidity between 45% and 55%.

| | Time | Weibull Parameter | Weibull | |
|---|---|---|---|---|
| Composition | [weeks] | α [kV/mm] | parameter B [−] | tan δ @ 1 kHz |
| Pure | 1 | 126.4 | 7.82 | 0.0003 |
| | 3 | 92.6 | 12.86 | 0.0002 |
| | 5 | 55.0 | 5.64 | 0.0193 |
| 3 wt. % SiO₂ | 1 | 98.5 | 14.40 | 0.0004 |
| | 3 | 112.2 | 5.26 | 0.0003 |
| | 5 | 45.6 | 10.76 | 0.0338 |
| 3 wt. % MgO | 1 | 129.3 | 15.71 | 0.0003 |
| | 3 | 97.0 | 7.08 | 0.0014 |
| | 5 | 92.3 | 2.10 | 0.0003 |

ATR-FTIR Spectroscopy of XLPE Nanocomposites

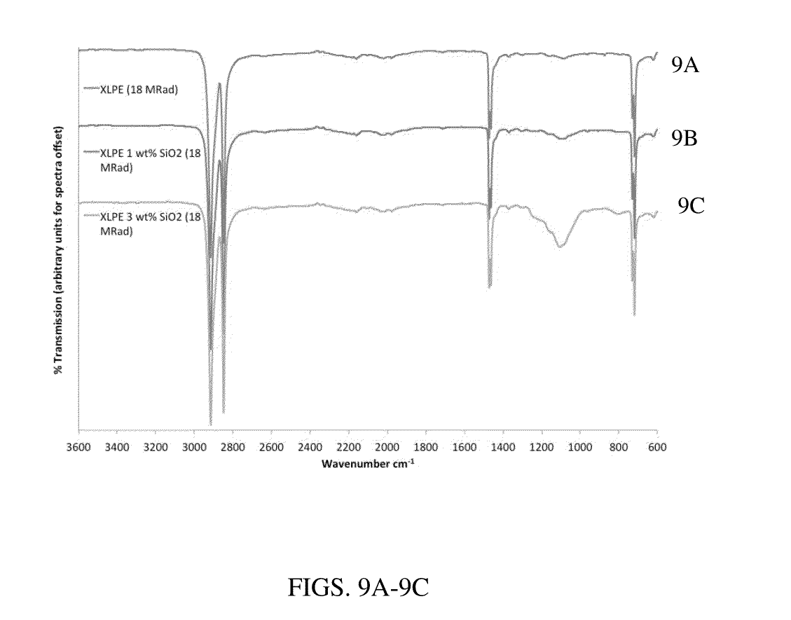

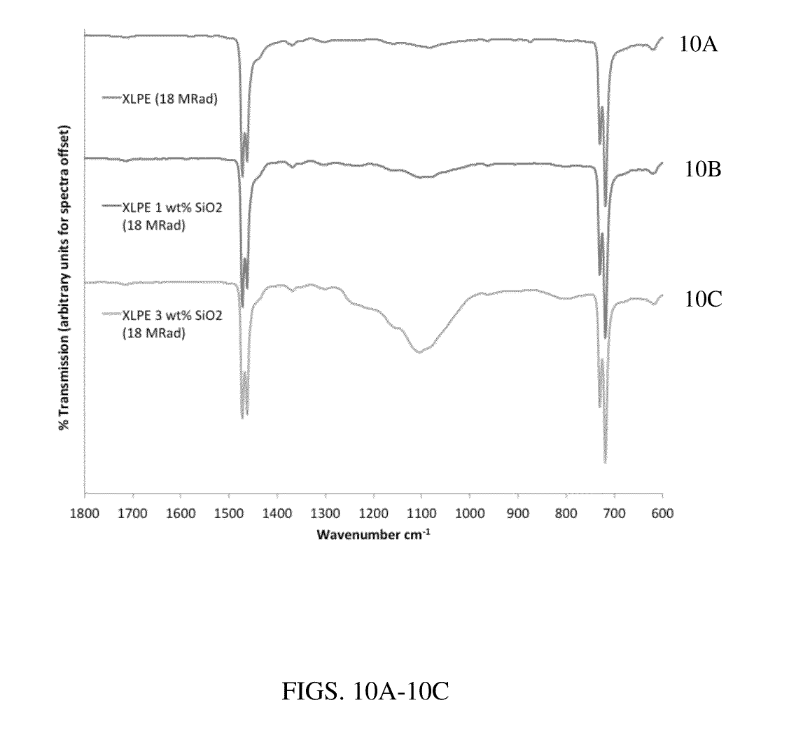

Attenuated total reflectance Fourier transform infrared spectroscopy (ATR-FTIR) was conducted on a section of each film in an effort to quantify the nature of the chemical change in the XLPE nanocomposites. FIGS. 9A-9C show ATR-FTIR spectra for irradiated XLPE SiO₂ nanocomposites at 18 MRad dosage for XLPE only (FIG. 9A), XLPE with 1 wt % SiO₂ nanoparticles (FIG. 9B), and XLPE with 3 wt % SiO₂ nanoparticles (FIG. 9C). FIGS. 10A-10C show ATR-FTIR spectra for thermally aged XLPE with 3 wt. % SiO₂ nanoparticles after undergoing treatment at 120° C. for 1 week (FIG. 10A), 3 weeks (FIG. 10B), and 5 weeks (FIG. 10C). Since the irradiation of XLPE SiO₂ nanocomposites was conducted under an argon environment, the increase in the peak intensity observed at wavenumber 1105 cm⁻¹/1106 cm⁻¹ likely corresponds to the increase in SiO₂ concentration in the films and is not necessarily associated with the damage from the irradiation itself. From FIGS. 10A-10C, it is evident that, once the XLPE nanocomposite with 3 wt. % SiO₂ is aged for five weeks at 120° C., a rapid drop in the absorbed IR is observed near the location of SiO₂. This change, as well as changes in other regions of the IR spectra of FIGS. 10A-10C, suggest possible changes in the silicon and oxygen bonds. The spectra for both the 3-week aged (FIG. 10B) and 18 MRad exposure sample for the 3 wt. % SiO₂ XLPE material (FIG. 9C) are very similar. Measurement of the cross-linking concentration and oxidation time for each sample may ultimately reveal the nature of the SiO₂ interactions.

### CONCLUSIONS

The XLPE nanocomposites with the addition of SiO₂ and MgO have been successfully developed and their electrical performance after irradiation and thermal aging has been studied. Depending on the composition, the performance of the insulation was affected, both positively and negatively, when quantified with respect to its electrical properties. The XLPE nanocomposite with 1 wt. % SiO₂ showed an improvement in breakdown strength and reduction in its dissipation factor when compared to pure XLPE, while XLPE 3 wt. % SiO₂ resulted in lower breakdown strength. When XLPE nanocomposites were irradiated to 18 MRad, the differences between irradiated and non-irradiated XLPE nanocomposites became greater with respect to breakdown strength, especially with SiO₂ concentrations greater than 3 wt. %. ATR-FTIR measurements elucidated changes in the IR spectrum with increasing concentration of SiO₂ particles and increasing thermal aging period.

With respect to cable aging, it is evident that the XLPE nanocomposites are advantageous when compared to pure XLPE when the electrical responses of the samples are considered. Since the change in the dissipation factor influences the cable impedance, a time or frequency domain reflectometry might be more responsive to XLPE nanocomposites. An XLPE nanocomposite that could indicate larger drops in resistance without compromising the electrical integrity of the insulation would permit identification of abnormal changes in condition that conventional materials would not be able to show. In addition, given the potential application of FTIR spectroscopy to cable aging management, more sensitive markers in the materials could be identified and correlated with the time or frequency domain reflectometry analysis, which in turn could allow for earlier identification of abnormal conditions. Future work on these materials across a broader spectrum of temperatures, air exposures, and radiation conditions would help identify key aging mechanisms with XLPE nanocomposite formulations that would, in general, benefit the implementation of cable insulation in a variety of applications.

While there have been shown and described what are at present considered the preferred embodiments of the invention, those skilled in the art may make various changes and modifications which remain within the scope of the invention defined by the appended claims.

What is claimed is:

1. A method for producing a polymer-metal oxide composite material resistant to degradation resulting from exposure to gamma irradiation, the method comprising exposing a composite precursor comprised of a heat-resistant polymer in which metal oxide nanoparticles are incorporated to gamma irradiation of at least 1 MRad in a flowing gas atmosphere for a period of at least 12 hours.

2. The method of claim 1, wherein said gamma irradiation is at least 5 MRad.

3. The method of claim 1, wherein said gamma irradiation is at least 10 MRad.

4. The method of claim 1, wherein said gamma irradiation is at least 20 MRad.

5. The method of claim 1, wherein said gamma irradiation is up to 150 MRad.

6. The method of claim 1, wherein said gas is argon or nitrogen.

7. The method of claim 1, wherein said gas is air.

8. The method of claim 1, wherein said method further comprises subjecting the composite precursor, during exposure to gamma irradiation, to an elevated temperature of at least 40° C. and below a thermal degradation temperature of the heat-resistant polymer.

9. The method of claim 8, wherein said elevated temperature is at least 50° C.

10. The method of claim 8, wherein said elevated temperature is at least 80° C.

11. The method of claim 8, wherein said elevated temperature is at least 100° C.

12. The method of claim 1, wherein said heat-resistant polymer is selected from a polyimide, cross-linked polyethylene (XLPE), polyaryletherketone (PAEK), polyetherimide (PEI), ethylene propylene rubber (EPR), ethylene propylene diene monomer (EPDM) rubber, chlorosulfonated polyethylene (CSPE) synthetic rubber, polytetrafluoroethylene (PTFE), polysulfone, polybenzimidazole (PBI), polyvinyl chloride (PVC), chlorinated polyvinyl chloride (CPVC), polyphthalamide (PPA), silicone rubber (SiR), polybenzoxazole, polybenzothiazole, poly(p-phenylene sulfide), and polyquinoxaline, and blends and composites thereof.

13. The method of claim 1, wherein said metal oxide comprises an alkaline earth metal oxide.

14. The method of claim 1, wherein said metal oxide comprises a main group metal oxide, wherein said main group metal is selected from boron, aluminum, gallium, indium, silicon, germanium, tin, lead, antimony, and bismuth.

15. The method of claim 1, wherein said metal oxide comprises a transition metal oxide.

16. The method of claim 1, wherein said metal oxide is present in an amount of at least 1 wt % and up to 10 wt % by weight of the polymer-metal oxide composite material.

17. The method of claim 1, wherein said metal oxide is present in an amount of at least 1 wt % and up to 5 wt % by weight of the polymer-metal oxide composite material.

18. The method of claim 1, wherein said metal oxide is present in an amount of at least 1 wt % and up to 3 wt % by weight of the polymer-metal oxide composite material.

19. The method of claim 1, wherein said metal oxide is present in an amount of at least 3 wt % and up to 5 wt % by weight of the polymer-metal oxide composite material.

20. The method of claim 1, wherein said composite precursor is prepared prior to exposing the composite precursor to gamma irradiation.

21. The method of claim 1, wherein said composite precursor has a tubular shape.

22. The method of claim 1, wherein said composite precursor has a planar shape.
